(19) United States
(12) Patent Application Publication
(10) Pub. No.: US 2014/0193009 A1
(43) Pub. Date: Jul. 10, 2014

(54) METHOD AND SYSTEM FOR ENHANCING THE INTELLIGIBILITY OF SOUNDS RELATIVE TO BACKGROUND NOISE

(71) Applicant: Demetria Z. Loizou, Plano, TX (US)

(72) Inventors: Nima Yousefian Jazi, Dallas, TX (US); Philipos C. Loizou, Plano, TX (US)

(73) Assignee: The Board of Regents of the University of Texas System, Austin, TX (US)

(21) Appl. No.: 13/990,942

(22) PCT Filed: Dec. 6, 2011
(86) PCT No.: PCT/US11/63589

§ 371 Date: Feb. 23, 2014

Related U.S. Application Data
(60) Provisional application No. 61/419,936, filed on Dec. 6, 2010.

(51) Int. Cl. H04R 25/00

(52) U.S. Cl. CPC H04R 25/453
USPC 381/317

(57) ABSTRACT

A novel dual-microphone speech enhancement technique is proposed that utilizes the coherence function between input signals as a criterion for noise reduction. The technique is based on certain assumptions regarding the spatial properties of the target and noise signals and can be applied to arrays with closely spaced microphones, where noise captured by sensors is highly correlated (e.g., inside a mildly reverberant environment). The proposed algorithm is simple to implement and requires no estimation of noise statistics. In addition, it offers the advantage of coping with situations in which multiple interfering sources located at different azimuths might be present.

### CROSS REFERENCES TO RELATED APPLICATIONS

This Application claims the benefit under 35 U.S.C. 119(e) of U.S. Provisional Patent Application Ser. No. 61/419,936 filed Dec. 6, 2010, which is incorporated herein by reference in its entirety as if fully set forth herein.

### STATEMENT REGARDING FEDERALLY-SPONSORED RESEARCH OR DEVELOPMENT

This invention was made with government support under Grant No. 6-32430 awarded by the National Institutes of Health. The government has certain rights in the invention.

### TECHNICAL FIELD

The claimed invention relates to a method and system for enhancing the intelligibility of sounds relative to background noise and has particular application for listening devices such as hearing aids, bone conductors, cochlear implants, assistive listening devices, and active hearing protectors. Embodiments of the invention generally relate to hearing assistance devices and in particular to methods and apparatus for improved noise reduction for hearing assistance devices.

### BACKGROUND TO THE INVENTION

One of the most common complaints in hearing impaired subjects is reduced speech intelligibility in noisy environments. In realistic listening situations, speech is often contaminated by various types of background noise. Noise reduction algorithms for digital hearing aids have received growing interest in recent years. Although a lot of research has been performed in this area, a limited number of techniques have been used in commercial devices. One main reason for this limitation is that many noise reduction techniques perform well in the laboratory, but lose their effectiveness in everyday life listening conditions.

Generally, three types of noise fields are investigated in multi-microphones speech enhancement studies: (1) incoherent noise caused by the microphone circuitry, (2) coherent noise generated by a single well-defined directional noise source and characterized by high correlation between noise signals (3) diffuse noise, which is characterized by uncorrelated noise signals of equal power propagating in all directions simultaneously. Performance of speech enhancement methods is strongly dependent on the characteristics of the environmental noise they are tested in. Hence, the performance of methods that work well in the diffuse field starts to degrade when tested in coherent noise fields.

Modern hearing assistance devices, such as hearing aids typically include a digital signal processor in communication with a microphone and receiver. Such designs are adapted to perform a great deal of processing on sounds received by the microphone. These designs can be highly programmable and may use inputs from remote devices, such as wired and wireless devices.

Numerous noise reduction approaches have been proposed. However, noise reduction algorithms can result in decreased intelligibility and audibility of speech due to speech distortion from the application of the noise reduction algorithm.

Accordingly, there is a need for methods and apparatus for improved noise reduction for hearing assistance devices. Such methods should address and reduce speech distortion to enhance intelligibility and audibility of the speech.

### SUMMARY OF THE INVENTION

An embodiment of the invention provides an algorithm is capable of suppressing noise captured by two close microphones. The method is based on the coherence function of noisy signals at the two channels. Coherence is a complex frequency function and indicates how two signals are correlated at each frequency bin. Traditionally, magnitude of the coherence function is used as criterion for determining the possibility of presence of speech at each component. The claimed method is based on real and imaginary part of this function and suppresses background noise assuming that the received signal originates from the front (desired target signal) or from other range of angles (noise signals).

Another embodiment of the invention provides a coherence-based technique capable of dealing with coherent noise, and applicable for hearing aid and cochlear implant devices.

Disclosed herein, are methods and apparatuses for improved noise reduction for hearing assistance devices. In various embodiments, a hearing assistance device includes a microphone and a processor configured to receive signals from the microphone. The processor is configured to perform noise reduction which adjusts maximum gain reduction as a function of signal-to-noise ratio (SNR), and which reduces the strength of its maximum gain reduction for intermediate signal-to-noise ratio levels to reduce speech distortion. In various embodiments, the hearing assistance device includes a memory configured to log noise reduction data for user environments. The processor is configured to use the logged noise reduction data to provide a recommendation to change settings of the noise reduction, in an embodiment. In various embodiments, the processor is configured to use the logged noise reduction data to automatically change settings of the noise reduction.

In various embodiments of the present subject matter, a method includes receiving signals from a hearing assistance device microphone in user environments and adjusting maximum gain reduction as a function of signal-to-noise ratio to perform noise reduction. Various embodiments of the method include reducing the strength of the maximum gain reduction for intermediate signal-to-noise ratio levels to reduce speech distortion.

The Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIGS. 1A to 1D shows a comparison between the true SNR at the front microphone and its predicted values by the proposed algorithm, for four different frequencies. The noise source is located at 90° azimuth and SNR=0 dB (speech-weighted noise);

FIG. 2 illustrates a block diagram of the proposed two-microphone speech enhancement technique;

FIG. 3 shows a block diagram of the two microphone adaptive beamformer used for comparative purposes;

FIGS. 4A-4D show SRT results of seven normal-hearing subjects in the different noise configurations. Numbers indicate the SNR (dB) required to understand 50% of the words correct. Error bars indicate standard deviation;

FIG. 5 shows SRT improvements of the beamformer and proposed algorithm over the DIR in the different noise configurations. Error bars indicate standard deviations;

FIG. 6 shows PESQ scores obtained in different noise scenarios; and

FIGS. 7A-7D illustrate spectrograms of the clean speech signal (top left) and DIR signal (top right). Speech is degraded by interfering speech (SNR=0 dB) located at 90° azimuth. Bottom left panel shows enhanced signal by the beamformer and bottom right panel shows enhanced signal by the proposed coherence-based algorithm. The target IEEE sentence was “Glue the sheet to the dark blue background” uttered by a male speaker and the masker sentence was “He is completing his apprenticeship at the funeral home” uttered by a female speaker.

### DETAILED DESCRIPTION OF EXEMPLARY EMBODIMENTS

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

An embodiment of the invention shows how the coherence function can be used as a criterion for noise reduction.

Coherence is a function of frequency with values between zero and one and an indicator of how well two signals correlate to each other at each frequency. Assume two microphones are placed in a noisy environment in which the noise and target speech signals are spatially separated. In this case, the noisy speech signals, after delay compensation, can be defined as

yᵢ(m)=xᵢ(m)+nᵢ(m) (i=1, 2) (1)
where i denotes the microphone index, m is the the sample-index and xᵢ(m) and nᵢ(m) represent the (clean) speech and noise components in each microphone, respectively.

After applying a short-time discrete Fourier transform (DFT) on both sides of the above equation, it can be expressed in the frequency domain as

Yᵢ(ωᵢ, k)=Xᵢ(ωᵢ, k)+Nᵢ(ωᵢ, k) (i=1, 2) (2)
where k is the frame index, ωᵢ=2πl/L and l=0, 1, 2, . . . , L−1, where L is the frame length in samples. In subsequent equations, the subscript “1” has been omitted for better clarity and ω is referred to as the angular frequency.

The coherence function is a measure of linear relationship between two random processes. It shows the degree of correlation between the components at a particular frequency. Coherence is a complex valued function and between two arbitrary signals is defined as

$${Γ}_{{u}_{1} {u}_{2}} ( ω , k ) = \frac{{Φ}_{{u}_{1} {u}_{2}} ( ω , k )}{\sqrt{{Φ}_{{u}_{1} {u}_{1}} ( ω , k ) {Φ}_{{u}_{2} {u}_{2}} ( ω , k )}} \qquad ( 3 )$$

where Φᵤᵥ (ω, k) denoes the cross-power spectral density (CSD) defined as Φᵤᵥ (ω, k)=E[U (ω, k)V*(ω, k)], and Φᵤᵤ (ω, k) denotes power spectral density (PSD) defined as Φᵤᵤ (ω, k)=E[(U (ω, k))²]. The coherence function assumes a value close to 1 if the two signals are correlated and a value close to 0 if they are uncorrelated. The coherence function can be analytically modeled based on the noise filed. In a diffuse noise field, the coherence function is real-valued and its value increases as the distance between two microphone decreases. Coherent noise field is generated from a single well-defined directional sound source, and for two closely-spaced omnidirectional microphones captured signals are perfectly coherent except for a time delay.

Γᵤ₁ᵤ₂(ω)=e^{jωf}^{ₛ}^{(d/c)cos θ} (4)
where θ is the angle of incidence, fₛ is the sampling frequency, c≅340 m/s is the speed of sound and “d” the microphone spacing.

To describe the proposed SNR the below equation is used:

$$\begin{matrix}{Γ}_{y 1 y 2} = {Γ}_{x 1 x 2} ( \sqrt{\frac{{SNR}_{1}}{1 + {SNR}_{1}} \frac{{SNR}_{2}}{1 + {SNR}_{2}}} ) + \\ {Γ}_{n 1 n 2} ( \sqrt{\frac{1}{1 + {SNR}_{1}} \frac{1}{1 + {SNR}_{2}}} )\end{matrix} \qquad ( 5 )$$

where Γ_{y1y2}, Γₓ₁ₓ₂ and Γₙ₁ₙ₂ denote the coherence function between noisy input, clean speech and noise signals at two microphones respectively, and SNR₁ and SNR₂ denote local SNR values at the two channels. In the above equation the ω and k indices were omitted for sake of clarity. Since the distance between microphones in the present configuration is fairly small (˜20 mm) it can be assumed that SNR1≅SNR2. Therefore, the last equation can be modified as follows

$${\hat{Γ}}_{{y}_{1} {y}_{2}} ≃ {Γ}_{{x}_{1} {x}_{2}} \frac{S \hat{N} R}{1 + S \hat{N} R} + {Γ}_{{n}_{1} {n}_{2}} \frac{1}{1 + S \hat{N} R} \qquad ( 6 )$$

where S\hat{N}R is an approximation to both SNR1 and SNR2. After applying (4) the last equation can be rewritten as follows;

$${\hat{Γ}}_{{y}_{1} {y}_{2}} ≃ [ cos ( ω τ ) + j sin ( ω τ ) ] \frac{S \hat{N} R}{1 + S \hat{N} R} + [ cos ( ω τ cos θ ) + j sin ( ω τ cos θ ) ] \frac{1}{1 + S \hat{N} R} \qquad ( 7 )$$

where τ=fₛ (d/c). By taking the real part of the equation,

$$ℜ = \frac{S \hat{N} R}{1 + S \hat{N} R} cos \dot{ω} + \frac{1}{1 + S \hat{N} R} cos α \qquad ( 8 )$$

where [symbol] is the real part of Γ_{y1y2}, \dot{ω}=ωτ and α=\dot{ω} cos θ.

By rearranging terms in the previous equation, the following equation is obtained:

$$S \hat{N} R = \frac{cos α - ℜ}{ℜ - cos \dot{ω}} \qquad ( 9 )$$

By taking the imaginary part of (7) the following equation is obtained

$$( 10 )$$

where [symbol] is the imaginary part of Γy1y2

By rearranging the terms in the last equation, the following equation is obtained:

$$S \hat{N} R = \frac{sin α -}{- sin \dot{ω}} \qquad ( 11 )$$

Since the right-hand sides of (9) and (11) are equal, S\hat{N}R can be removed and combined into a single equation as follows:

( [symbol] −sin \dot{ω})cos α+(cos \dot{ω}− [symbol] )sin α+ [symbol] sin \dot{ω}− [symbol] cos \dot{ω}=0 (12)

In the last equation, the only unknown parameter is α. By introducing the following variables:

$$\{ \begin{matrix}A = - sin \dot{ω} \\ B = cos \dot{ω} - \\ C = sin \dot{ω} - cos \dot{ω}\end{matrix} \qquad ( 13 )$$

(12) can be rewritten as:

A cos α=−B sin α−C (14)

By raising both sides of the last equation to the power of two, and using the fact that cos²α=1−sin²α, (14) can be substituted by the following quadratic equation:

(A²+B²)sin²+2B C sin α+(C²−A²)=0 (15)
which yields two solutions, as shown below:

$$sin α = \frac{- BC \pm \sqrt{{B}^{2} {C}^{2} - ( {C}^{2} - {A}^{2} ) ( {A}^{2} + {B}^{2} )}}{{A}^{2} + {B}^{2}} \qquad ( 16 )$$

The last equation can be rewritten in a simpler form as follows:

$$sin α = \frac{- BC \pm \vert A \vert \sqrt{{A}^{2} + {B}^{2} - {C}^{2}}}{{A}^{2} + {B}^{2}} \qquad ( 17 )$$

As is shown in Appendix A, the inside of the square root is always positive, and is equal to the square of:

T=1− [symbol] cos \dot{ω}− [symbol] sin \dot{ω} (18)

One solution of sin α in (17) is trivial and leads to sin α=sin \dot{ω} and therefore from (11), S\hat{N}R=1, which is not possible since both PSDs of speech and noise signals are always positive. After replacing A, B and C by their actual values and some manipulations it can be shown that the solution with negative root is the correct one when T and A have same signs, otherwise positive root will lead to the correct solution. After computing the value of sin α, we can calculate the S\hat{N}R using (11).

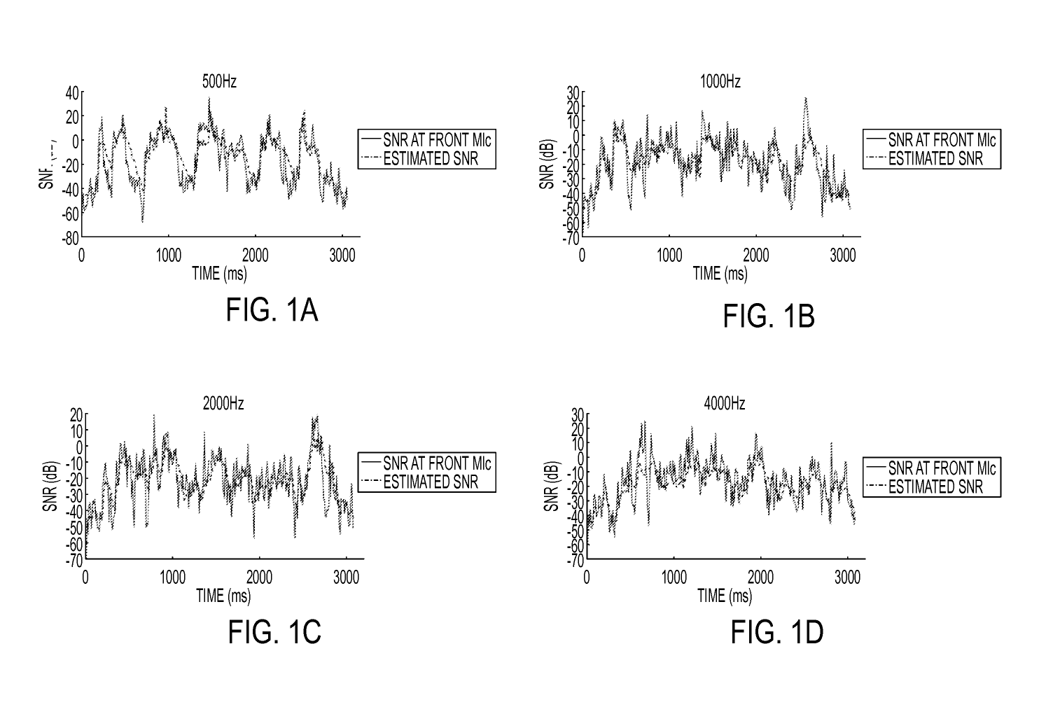

To verify the validity of the above SNR estimation algorithm, FIG. 1 shows a comparison between the true SNR values at the front microphone and the approximation obtained using the proposed algorithm. SNR values shown in FIGS. 1A to 1D correspond to a sentence (produced by a male speaker) corrupted by a speech-weighted noise located at 90°. A comparison was made for four different frequencies. As is evident from the figure, in both low and high frequency ranges, the estimated SNR values follow the true SNR values quite well. To assess how close the approximation of SNR is to the true one, we quantify the errors using root mean square error (RMSE) defined as follows:

RMSE_{SNR}(ω)={square root over (E[(SNR(ω)−S\hat{N}R(ω))²])} (19)

In the above equation the expected value was computed over all frames. This measure assesses the distance between the true and predicted SNR, and lower values of the error indicate higher accuracy of the approximation. Table I below shows results of the above measures averaged over 10 sentences. For this evaluation, speech-weighted noise was used at 90° and SNR was measured in dB.

TABLE I

| Frequency | | Input SNR | | RMSE_{SNR} (dB) |
|---|---|---|---|---|
| 500 | Hz | −5 | dB | 2.72 |
| 1 | kHz | −5 | dB | 3.45 |
| 2 | kHz | −5 | dB | 4.25 |
| 4 | kHz | −5 | dB | 4.90 |
| 500 | Hz | 0 | dB | 4.13 |
| 1 | kHz | 0 | dB | 4.97 |
| 2 | kHz | 0 | dB | 4.75 |
| 4 | kHz | 0 | dB | 4.91 |

It has previously been shown that a priori SNR based approach leads to the best subjective results. In the present invention, the Wiener filter is defined as:

$$G ( ω , k ) = \sqrt{\frac{S \hat{N} R ( ω , k )}{S \hat{N} R ( ω , k ) + 1}} \qquad ( 20 )$$

The implementation details of the proposed coherence-based method are described below. In an embodiment of the invention, the two signals captured by the microphones are first processed in 20 ms frames with a Harming window and a 50% overlap between adjacent frames. Based on the short-time Fourier transform of the two signals calculated, the PSDs and CSD are computed using the following two first order recursive equations:

Φ_{y1y2}(ω, k)=λΦ_{y1y2}(ω, k−1)+(1−λ)|Yᵢ(ω, k)|² (i=1, 2) (21)

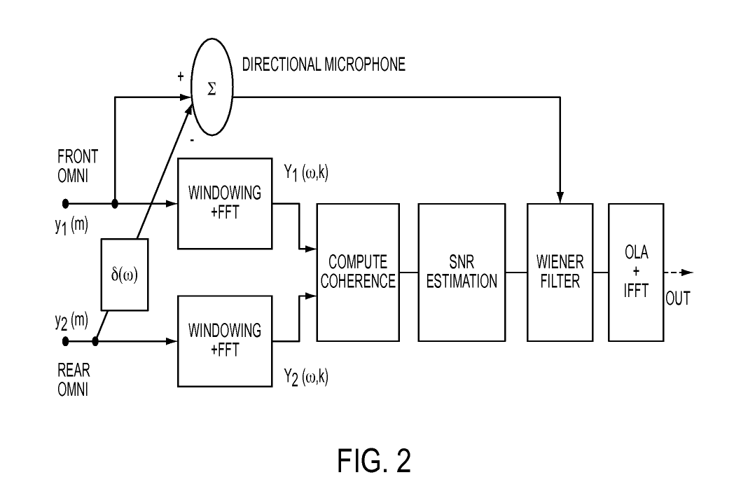

Φ_{y1y2}(ω, k)=λΦ_{y1y2}(ω, k−1)+(1−λ)Y₁(ω, k)Y₂*(ω, k) (22)
where (−)* denotes the complex conjugate operator and λ is a forgetting factor, set between 0 and 1. In the present invention, A is set to 0.6. FIG. 2 shows the procedure of speech enhancement with the proposed method in a block diagram. As shown in the block diagram, a software directional microphone is created by the two omnidirectional microphones. The directional microphone parameter is δ(ω)=αe^{-jωΔ}^{₀}, where a and Δo are set so as to obtain a hypercardioid polar diagram in anechoic conditions (null at 110°). This approach is referred to as directional microphone (DIR) approach. To obtain an enhanced signal, a suppression function is applied to the Fourier transform of the signal corresponding to DIR. To reconstruct the enhanced signal in the time-domain, an inverse FFT is applied and the signal is synthesized using the overlap-add (OLA) method.

In an embodiment of the invention, the suggested technique was tested inside an almost anechoic room (T₆₀≅80 ms). Generally, in a reverberant environment, the noise signals at the two microphones will be less correlated. In such conditions, the environmental noise gets characteristics of the diffuse noise field, and therefore equation (4) does not hold anymore. Although considering a small microphone spacing, it can still be assumed that the noise signals are highly correlated for a wide range of frequencies, the method loses its ability to suppress the noise components that are not highly correlated. The problem of dealing with uncorrelated noise components has been also investigated for beamformers. It has been suggested that by passing the output of beamformer through a post-filter, such as a Wiener filter, uncorrelated noise components can be dealt with that can not be easily suppressed by beamformers.

### WORKING EXAMPLES

### A. Test Materials and Subjects

Sentences taken from the IEEE database corpus (designed for assessment of intelligibility) were used. These sentences (approximately 7-12 words) are phonetically balanced with relatively low word-context predictability. The root-mean-square amplitude of sentences in the database was equalized to the same root-mean-square value, which was approximately 65 dBA. The sentences were originally recorded at a sampling rate of 25 kHz and downsampled to 16 kHz.

Two types of noise (speech-weighted and competing talker) were used as maskers. The speech-weighted noise used, was adjusted to match the average long-term spectrum of the speech materials. The competing talker sentences used as maskers were taken from the AzBio corpus. The database was developed to evaluate the speech perception abilities of hearing-impaired listeners and CI users. The sentence corpus includes 33 lists, each containing 20 sentences recorded from two female and two male speakers.

Seven normal hearing listeners, all native speakers of American English, participated in the listening test. Their ages ranged from 18 to 23 years (mean of 20 years). The listening tests were conducted in a double-walled sound-proof booth via Sennheiser HD 485 headphones at a comfortable level.

### B. Methods and Noise Configurations

The noisy stimuli at the pair of microphones were generated by convolving the target and noise sources with a set of HRTFs (head-related transfer functions) measured inside a mildly reverberant room (T₆₀≅80 ms) with dimensions 3.8×4.33×2.2 m³ (length×width×height).

The HRTFs were measured using identical microphones to those used in modern hearing aids. The noisy sentence stimuli were processed using the following conditions: (1) the software directional microphone (DIR), used as a baseline, (2) an adaptive beamformer algorithm and (3) the coherence-based algorithm of the present invention.

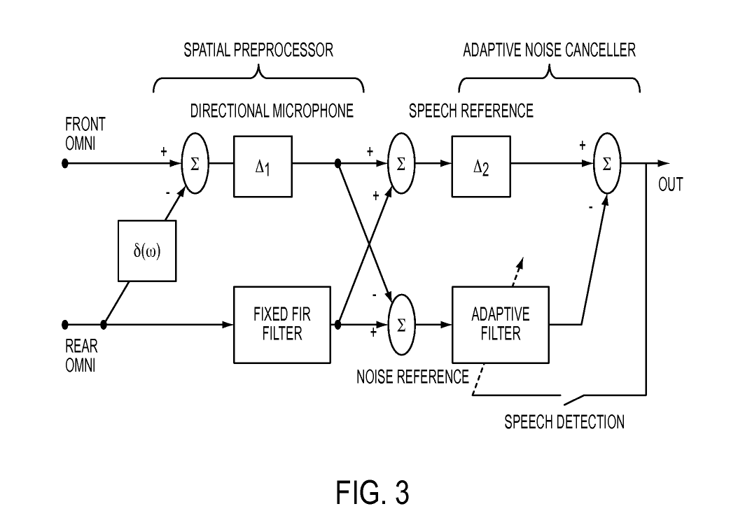

The adaptive algorithm against which the present method was compared is the two-stage beamformer, which has been used widely in both hearing aid and cochlear implant devices. The two-stage adaptive beamformer is an extension of the GSC technique. A block diagram of the beamformer is depicted in FIG. 3. In the implementation of the beamformer, the adaptive filter has 32 taps, and the coefficients are updated by a Normalized-Least Mean Square (NLMS) procedure. The FIR filter 10 coefficients were fixed to give a specific look direction to the two-stage adaptive beamformer, Δ₁ and Δ₂ are additional delays and their values were set to half of the size of the filters.

The test was carried out in four different noise scenarios. In one of them, a single noise source generating speech-weighted noise was placed at 45°. In the other three noise conditions, competing talkers are used as interfering sources: (a) one talker at 90°, (b) two talkers at (90°, 180°), and (c) two talkers at (90°, 270°). The talker at 90° is a female speaker and the other talker is a male speaker.

In order to investigate speech intelligibility obtained by the different algorithms, the SRT measurement technique was used. At the start of each SRT measurement, the subject listens to noisy stimuli with very low SNR. Then, he/she repeats as many words as possible. After each response, the same target sentence and interferer combination is replayed with +4 dB shift in SNR repeatedly, until the subject reproduced more than half of the sentence correctly. From that point, actual SRT measurement begins using a one-down/one-up adaptive SRT technique targeting 50% correct speech reception. In the present implementation, SNR step size is 2 dB and SRT was determined by averaging the SNR level presented in last eight trials.

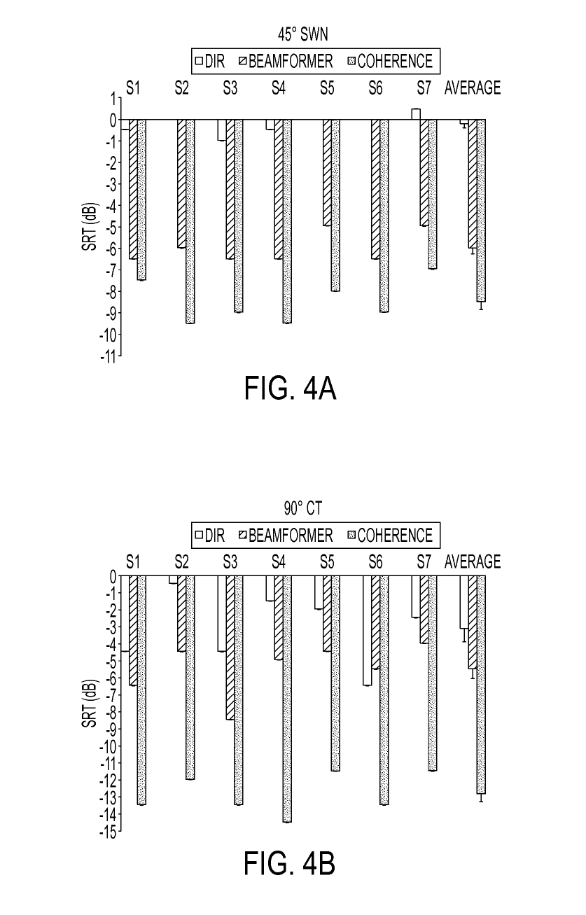

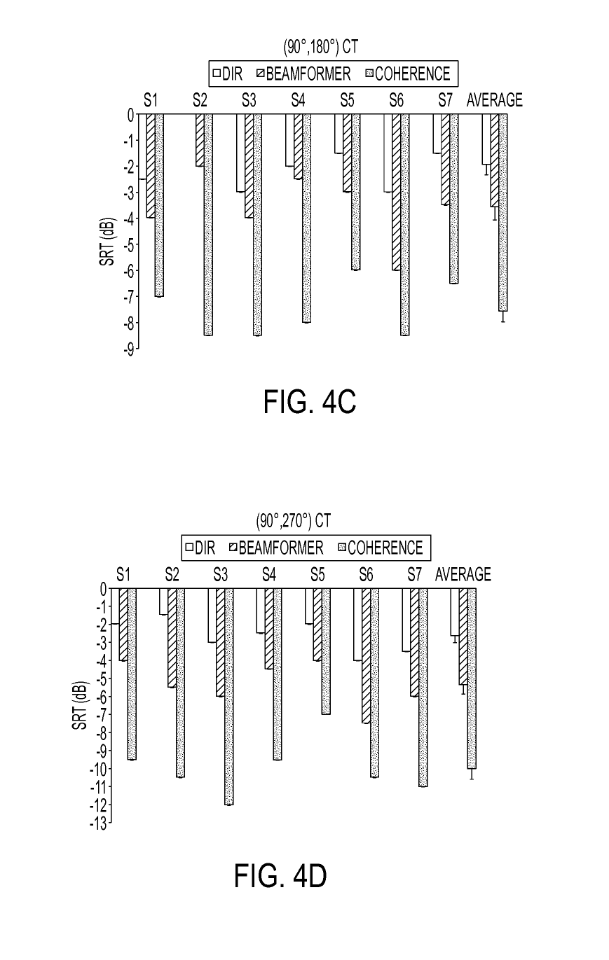

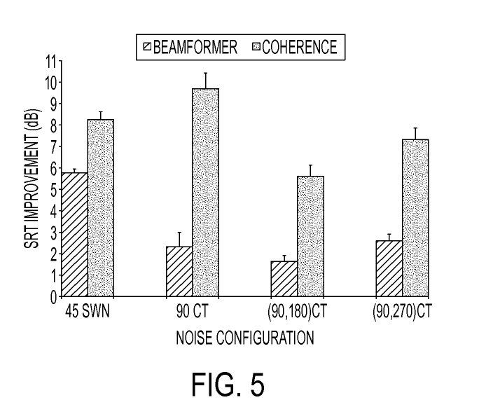

SRT scores of the different methods for all seven listeners are presented in FIGS. 4A 4D. FIG. 5 shows the improvements in SRT, obtained with the beamformer and proposed algorithm over the DIR system. As is apparent from FIG. 5, both the beamformer and proposed technique yield more than 5 dB improvement, when speech-weighted noise is located at 45°.

However, in contrast to the algorithm presented herein, the beamformer does not provide a noticeable benefit over the DIR system in the noise scenarios with competing talkers. As it is also clear from the figure the proposed algorithm shows more than 5 dB improvement for the different noise configurations with competing talkers, while the improvement with the bearnformer is about 2 dB. The reason for the poor performance of the beamformer with competing talker is that the beamformer relies on VAD decisions, and when speech is detected by the VAD the adaptation is turned off. In fact, the adaptive filter of the beamformer cannot update its tap coefficients when competing talker interfering signals are present. Therefore, the beamformer applies no suppression to the input signals in this case.

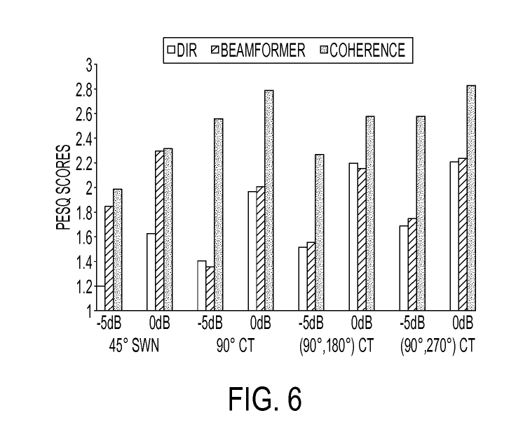

To assess the quality of speech signals, obtained by different methods, the Perceptual Evaluation of Speech Quality (PESQ) measure was used. This measure produces a score between 1.0 and 4.5, with larger values indicating better quality. In comparison to other conventional objective measures, the PESQ is the most complex to compute and is recommended for speech quality assessment of narrow-band handset telephony and speech codecs. A high correlation between the results of subjective listening tests and PESQ scores has been reported. To obtain the PESQ scores of different algorithms, two IEEE lists (20 sentences) were used per condition. FIG. 6 shows the resulting PESQ scores of the algorithms for the various noise scenarios, with input SNR equal to −5 dB and 0 dB. Clearly, the proposed coherence-based method outperforms DIR and the beamformer in all noise configurations involving competing talkers. In these cases, the proposed method achieved an average improvement of 0.8 relative to the scores of DIR and the beamformer. In the condition with speech-weighted noise at 45°, the scores of the beamformer are very close to those of our method. As can be seen in FIG. 6, the PESQ scores are consistent with the subjective listening tests results.

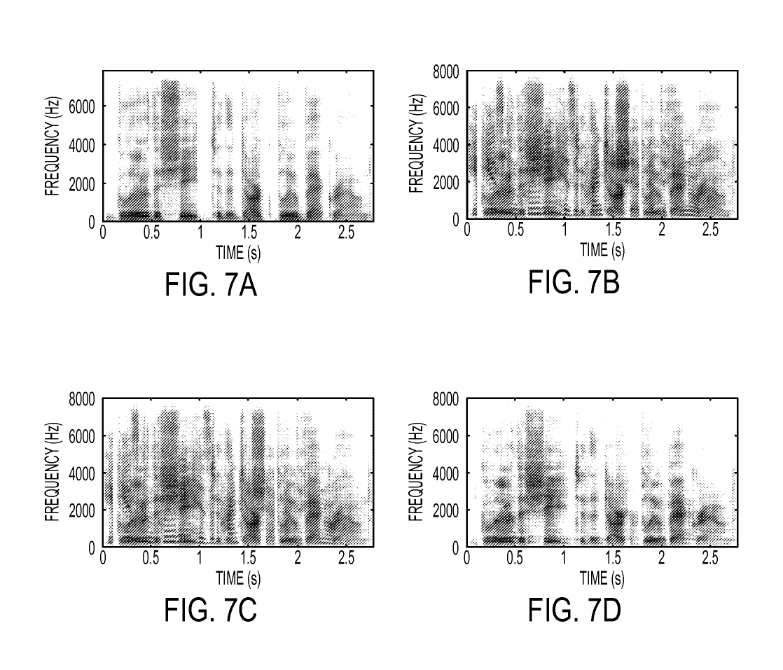

To observe the structure of the residual noise and speech distortion in the outputs of speech enhancement algorithms, sample spectrograms of clean and also those of the outputs of DIR, the beamformer and coherence-based method are presented in FIGS. 7A-7D. The figure shows that the background noise (competing talker) is more suppressed by the proposed method than by the beamformer, while the proposed method recovers the target speech signal components well. As it is also clear from the figure, the spectrograms of the beamformer is similar to that of DIR, and this confirms the fact that the beamformer almost keeps the input signal intact, when the interfering signal is a competing talker. These observations are in agreement with quality measurements results obtained with PESQ (see FIG. 6).

An embodiment of the invention is directed to development of a novel dual-microphone coherence-based technique for SNR estimation. By applying a Wiener filter based on these SNR estimates, the corresponding noise reduction algorithm was proposed. Large improvements in both quality and intelligibility were obtained with the proposed algorithm relative to the directional microphone (used as a baseline) and conventional beamforming technique, in particular in situations where either single or multiple competing talkers were present.

For humans, the problem of understanding one talker even if other persons are talking at the same time is called cocktail party phenomenon. Over the last decades, this problem has been mostly addressed in binaural noise reduction systems. However, less of dual microphone speech enhancement algorithms have been proposed to deal with competing talkers noise conditions. The main reason for this limitation is that dual microphone noise reduction algorithms usually need a noise estimator or VAD, since they require a prior knowledge of noise signal statistics. In general, estimating or detecting noise signals in adverse interference conditions, like competing talkers, is not a straightforward procedure. The SNR estimator we proposed in this paper, is a blind estimator, which does not rely on noise statistics. Based on the above discussion, the main advantage of our speech enhancement method is that, unlike the behavior of algorithms like beamformers, its performance is not dependent on the nature of the masker. Therefore, the improvement achieved by the proposed algorithm over the beamformer is more noticeable in low SNR and competing talkers scenarios, where noise estimation is a challenging problem.

Finally, a major benefit of the proposed algorithm is the ease of implementation. Generally, not all of noise reduction algorithms are performing well in laboratory tests can be utilized in hearing aid devices, for the reasons such as limit of hardware size, the number and distance between microphones, computational speed and power consumption. The algorithm presented herein is relatively simple in terms of computation and can be implemented in real-time. In fact, the proposed suppression filter (gain function) can easily be achieved by computing the coherence function between the input signals and solving a quadratic equation obtained from the real and imaginary parts of the coherence function. Based on the above discussion and the results obtained on both subjective and objective tests, the proposed method can be a potential candidate for future use in commercial hearing aids and cochlear implant devices.

### APPENDIX A

In this appendix, we prove that the term inside the square root in (17) is always positive. After replacing A, B and C by their actual values, we get the following expression for the term inside the square root of that equation:

[symbol]

+sin²\dot{ω}−2 [symbol] sin \dot{ω}+ [symbol] +cos² \dot{ω}−2 [symbol] cos \dot{ω}− [symbol] cos² \dot{ω}− [symbol] sin² \dot{ω}+2 [symbol] sin \dot{ω} cos \dot{ω} (23)

which can be replaced by

sin² \dot{ω}+cos² \dot{ω}+ [symbol] (1−cos² \dot{ω})+ [symbol] (1−sin² \dot{ω})−2 [symbol] sin \dot{ω}−2 [symbol] cos \dot{ω}+2 [symbol] sin \dot{ω} cos \dot{ω} (24)

Using the fact that sin² \dot{ω}+cos² \dot{ω}=1, the last equation can be written as

1+ [symbol] sin² \dot{ω}= [symbol] sin \dot{ω}+ [symbol] cos² \dot{ω}−2 [symbol] cos \dot{ω}+2 [symbol] sin \dot{ω} cos \dot{ω} (25)

the last equation is in fact (1− [symbol] cos \dot{ω}− [symbol] sin \dot{ω})², which is always positive.

The dual-microphone algorithm of the present invention utilizes the complex coherence function between the input and yields a SNR estimator, computed based on the real and imaginary parts of the coherence function. The algorithm makes no assumptions about the placement of the noise sources and addresses the problem in its general form. The suggested technique was tested in a dual microphone application (e.g., hearing aids) wherein a small microphone spacing exists. Intelligibility listening tests were carried out using normal-hearing listeners, who were presented with speech processed by the proposed algorithm and speech processed by a conventional GSC algorithm. Results indicated large gains in speech intelligibly and speech quality in both single and multiple-noise source scenarios relative to the baseline (front microphone) condition in all target-noise configurations. The algorithm was also found to yield substantially higher intelligibility and quality than that obtained by the beamformer. The simplicity of the implementation and intelligibility benefits make this method a potential candidate for future use in commercial hearing aid and cochlear implant devices.

The present application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

1. A hearing assistance device, comprising: a microphone; and a processor configured to receive signals from the microphone; and wherein the processor is configured to perform noise reduction which adjusts maximum gain reduction as a function of signal-to-noise ratio (SNR), and which reduces the strength of its maximum gain reduction for intermediate signal-to-noise ratio levels to reduce speech distortion.

2. The device of claim 1, further comprising a memory configured to log noise reduction data for user environments.

3. The device of claim 2, wherein the processor is configured to use the logged noise reduction data to provide a recommendation to change settings of the noise reduction to decrease speech distortion and improve speech audibility and intelligibility.

4. The device of claim 2, wherein the processor is configured to use the logged noise reduction data to automatically changing settings of the noise reduction to decrease speech distortion and improve speech audibility and intelligibility.

5. The device of claim 1, wherein the maximum gain reduction includes a dual microphone noise reduction algorithm (DMNR).

6. A method, comprising: receiving signals from a hearing assistance device microphone in user environments; adjusting maximum gain reduction as a function of signal-to-noise ratio to perform noise reduction; and reducing the strength of the maximum gain reduction for intermediate signal-to-noise ratio levels to reduce speech distortion.

7. The method of claim 6, further comprising logging noise reduction data for the user environments.

8. The method of claim 7, further comprising providing a recommendation to change settings of the noise reduction based on the logged data to decrease speech distortion and improve speech audibility and intelligibility.

9. The method of claim 7, further comprising automatically changing settings of the noise reduction based on the logged data to decrease speech distortion and improve speech audibility and intelligibility.

10. The method of claim 7, wherein logging noise reduction data includes logging which device memories have been used and how often the device memories have been used.

11. The method of claim 7, wherein logging noise reduction data includes logging average gain reduction during speech plus noise.

12. The method of claim 7, wherein logging noise reduction data includes logging average gain reduction during noise only.
